(19) United States
(12) Patent Application Publication
(10) Pub. No.: US 2005/0124715 A1
(43) Pub. Date: Jun. 9, 2005

(54) Dental compositions containing liquid and other elastomers

(76) Inventors: Gordon Mark Cohen, Wynnewood, PA (US); Donald Da-Jen Huang, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/936,357

(22) Filed: Sep. 8, 2004

Related U.S. Application Data
(60) Provisional application No. 60/526,821, filed on Dec. 3, 2003.

(51) Int. Cl. C08K 3/00

(52) U.S. Cl. 522/71

(57) ABSTRACT

The invention relates to a dental composite material wherein elastomeric compounds are utilized to reduce shrinkage upon polymerization; the invention also relates to a method for producing dental restoration articles with reduced shrinkage; the invention also relates to various dental restorative articles comprising the aforementioned elastomeric compounds.

### FIELD OF THE INVENTION

This invention relates to composite materials for restorative dentistry. More particularly, it relates to a dental composite material that combines reduced shrinkage with sufficiently low viscosity, high polymerization rate, and good mechanical properties.

### BACKGROUND OF THE INVENTION

In recent years, composite materials comprising highly filled polymer have become commonly used for dental restorations. A thorough summary of current dental composite materials is provided in N. Moszner and U. Salz, Prog. Polym. Sci. 26:535-576 (2001). Currently used dental filling composites contain crosslinking acrylates or methacrylates, inorganic fillers such as glass or quartz, and a photoinitiator system, enabling them to be cured by radiation with visible light. Typical methacrylate materials include 2,2′-bis[4-(2-hydroxy-3-methacryloyloxypropyl)phenyl]propane (“Bis-GMA”); ethoxylated Bis-GMA (“EBPDMA”); 1,6-bis-[2-methacryloyloxyethoxycarbonylamino]-2,4,4-trimethylhexane (“UDMA”); dodecanediol dimethacrylate (“D₃MA”); and triethyleneglycol dimethacrylate (“TEGDMA”).

Dental composite materials offer a distinct cosmetic advantage over traditional metal amalgam. However, they do not offer the longevity of amalgam in dental fillings. The primary reasons for failure are believed to be excessive shrinkage during photopolymerization in the tooth cavity, which causes leakage and bacterial reentry, and inadequate strength and toughness.

The incumbent low-shrink monomer, Bis-GMA, the condensation product of bisphenol A and glycidyl methacrylate, is an especially important monomer in dental composites. However, it is highly viscous at room temperature and consequently insufficiently converted to polymer. It is therefore typically diluted with a less viscous acrylate or methacrylate monomer, such as trimethylol propyl trimethacrylate, 1,6-hexanediol dimethacrylate, 1,3-butanediol dimethacrylate, ethylene glycol dimethacrylate, diethylene glycol dimethacrylate, TEGDMA, or tetraethylene glycol dimethacrylate. However, while providing fluidity, low molecular weight monomers contribute to increased shrinkage. Increasingly, Bis-GMA and TEGDMA have been combined with UDMA and ethoxylated-methacrylated versions of bisphenol A, but shrinkage remains too high.

Increasing the amount of inorganic filler in the composite has moderated shrinkage. However, the amount of filler that can be added is severely limited by the resulting increase in viscosity. Also, it has been reported that the increase in modulus more than offsets this benefit and can lead to an increased build-up of stress during shrinkage. This “contraction stress” is of great importance in that it can lead to mechanical failure and debonding of the composite from the tooth, creating a gap that can permit microleakage of oral fluid and bacteria, causing a reinfection.

Another approach has been to prepolymerize the monomer, reducing the ultimate degree of polymerization and attendant shrinkage. However, this reduces the amount of inorganic filler that can be added below current levels, thus decreasing the modulus and other mechanical properties.

Spiro-type, “expanding” monomers, introduced in the 1970s, eliminate shrinkage, but they have never been commercialized because they polymerize too slowly and they, or their polymerization products, are too unstable. Diepoxide monomers are similarly limited in that they polymerize slowly for practical application, and the monomers and photosensitizers may be too toxic. They do not entirely eliminate shrinkage.

Slow cure and the so-called “soft start” photocure are also reported to reduce contraction stress.

Other systems have been reported in the literature but are not commercial. Liquid crystalline di(meth)acrylates shrink far less, but there is a tradeoff in mechanical properties. Branched polymethacrylates and so-called “macromonomers” offer lower viscosity at reduced shrinkage, but cost of manufacture may be excessive.

U.S. Pat. No. 5,182,332 issued to Yamamoto et al. on Jan. 26, 1993, discloses a dental composition comprising grafted rubber, wherein the grafted rubber comprises a core consisting of polybutadiene, polystyrene, or a copolymer of styrene or methyl methacrylate with butyl acrylate, and an outer shell consisting of acrylate rubber.

Published German Application DE19617876 discloses the use of polysiloxane elastomers as an impact strength modifier in dental composites. The polysiloxane elastomers can be used as the core of a grafted rubber.

There remains a need for a dental composite material that combines reduced shrinkage with sufficiently low viscosity, high polymerization rate, and acceptable mechanical properties.

### SUMMARY OF THE INVENTION

The present invention provides a dental composite material comprising at least one (meth)acrylic ester compound, at least one polymerization initiator, at least one inorganic filler, and at least one elastomeric compound. The invention also provides a method of producing a dental restoration article using at least one (meth)acrylic ester compound, at least one polymerization initiator, at least one inorganic filler, and at least one elastomeric compound. Further provided is a method of treating dental tissue with a direct composite, comprising the steps of:
(a) placing a composite material, as described herein, on a dental tissue;
(b) curing the composite material; and
(c) shaping the composite material.

### DETAILED DESCRIPTION OF THE INVENTION

Applicants specifically incorporate the entire content of all cited references in this disclosure. Applicants also incorporate by reference the co-owned and concurrently filed applications entitled “Dental Composites Containing Core-Shell Polymers with Low Modulus Cores” (Attorney Docket # CL 2434), “Branched Highly-Functional Monomers Exhibiting Low Polymerization Shrinkage” (Attorney Docket # CL 2452), and “Bulky Monomers Leading to Resins Exhibiting Low Polymerization Shrinkage” (Attorney Docket # CL 2428).

In the context of this disclosure, a number of terms shall be utilized.

The terms “(meth)acrylic” and “(meth)acrylate” as used herein denote “methacrylic or acrylic” and “methacrylate or acrylate” respectively.

The term “dental composite material” as used herein denotes a composition that can be used to remedy natural or induced imperfections of, and relating to, teeth. Examples include filling materials, reconstructive materials, restorative materials, crown and bridge materials, inlays, onlays, laminate veneers, dental adhesives, teeth, facings, pit and fissure sealants, cements, denture base and denture reline materials, orthodontic splint materials, and adhesives for orthodontic appliances.

The term “liquid rubber” as used herein denotes a substantially noncrystalline polymer with a glass transition temperature (T_{g}) less than about 20° C. and a molecular weight low enough so that the compound flows at room temperature, that is the compound is pourable. Preferably the liquid rubber has a viscosity of less than about 2,000 Pa.s.

The term “first organic phase” as used herein denotes the (meth)acrylic esters and other organic compounds in a composite material and the polymers therefrom when the composite material is cured.

The term “second organic phase” as used herein denotes the phase that arises during cure of composites comprising the first organic phase and the elastomeric compounds of the invention. In one embodiment, the liquid rubber or other elastomer is miscible with the first organic phase prior to cure but begins to form a second phase that is at least partially immiscible with the first organic phase during the cure. This second phase optionally contains a portion of an at least one (meth)acrylic ester compound, which polymerizes during the cure. In a second embodiment, the elastomeric compound added to the first organic phase is at least partially immiscible with the first organic phase prior to cure and remains at least partially immiscible after cure.

Where a range of numerical values is recited herein, unless otherwise stated, the range is intended to include the endpoints thereof, and all integers and fractions within the range. It is not intended that the scope of the invention be limited to the specific values recited when defining a range.

The (meth)acrylic ester compound used in the present invention can comprise either a monofunctional compound or a polyfunctional compound which means a compound having one (meth)acrylic group and a compound having more than one (meth)acrylic group respectively. Specific examples of monofunctional (meth)acrylic ester compounds include methyl (meth)acrylate, ethyl (meth)acrylate, propyl (meth)acrylate, butyl (meth)acrylate, hydroxyethyl (meth)acrylate, benzyl (meth)acrylate, methoxyethyl (meth)acrylate, glycidyl (meth)acrylate, tetrahydrofurfuryl (meth)acrylate, and methacryloyloxyethyltrimellitic mono ester and its anhydride.

Specific examples of polyfunctional (meth)acrylic ester compounds include di(meth)acrylates of ethylene glycol derivatives as represented by the general formula 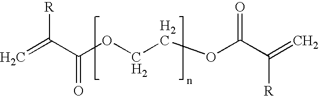
wherein R is hydrogen or methyl and n is an integer in a range of from 1 to 20, such as ethylene glycol di(meth)acrylate, diethylene glycol di(meth)acrylate, triethylene glycol di(meth)acrylate, and polyethylene glycol di(meth)acrylate; 1,3-butanediol di(meth)acrylate, 1,4-butanediol di(meth)acrylate, 1,6-hexanediol di(meth)acrylate, dodecanediol dimethacrylate, glycerol di(meth)acrylate, bisphenol A di(meth)acrylate, bisphenol A diglycidyl di(meth)acrylate and ethoxylated bisphenol A diglycidyl di(meth)acrylate; urethane di(meth)acrylates; trimethylolpropane tri(meth)acrylate; tetrafunctional urethane tetra(meth)acrylates; pentaerythritol tetra(meth)acrylate, dipentaerythritol penta(meth)acrylate, and hexa(meth)acrylates of urethanes having an isocyanuric acid skeleton.

These (meth)acrylic ester compounds may be used alone or in admixture of two or more. The mixtures can be mixtures of monofunctionals, polyfunctionals, or both.

The (meth)acrylic ester compound used in the dental compositions preferably comprises at least one polyfunctional (meth)acrylic ester compound, and more preferably comprises at least two polyfunctional (meth)acrylic ester compounds.

Surprisingly, it has been found that a low-modulus dispersed phase, a second organic phase, dissipates shrinkage stress through cavitation. By “low-modulus” is meant a modulus of elasticity at 100% elongation, M₁₀₀, below about 2,000 psi, preferably below about 1,000 psi, and more preferably below about 500 psi.

This low-modulus dispersed phase also offers the potential to enhance the fracture toughness of the composites in a manner similar to that of the soft, rubbery phases that toughen thermoplastics. If a soluble elastomer is used, the low-modulus dispersed phase forms as the polymerization proceeds, because the increase in molecular weight causes the dissimilar polymers to become immiscible. Alternatively, an insoluble rubber can be used if the high viscosity of the filled medium makes it possible to finely disperse this rubber and keep its particles from coalescing. Elastomers of lower molecular weight are advantageous for maintaining the relative fluidity of the organic phase so that the organic phase can tolerate a substantial amount of inorganic filler, that is, up to about 90 weight percent inorganic filler.

The elastomeric compound of the present invention comprises a liquid rubber or other elastomer, terms used interchangeably herein, added to the aforementioned (meth)acrylate monomers in order reduce polymerization shrinkage. Additionally, the elastomeric compounds can improve toughness and other mechanical properties. By “elastomeric compound” is meant a compound with a glass transition temperature (T_{g}) of less than about 20° C. and a melt index of at least about 100 g/10 min. at 190° C. Preferably the T_{g} of the elastomeric compound is less than about 0° C., and more preferably the T_{g} is less than about −20° C. Furthermore, the elastomeric compound is substantially noncrystalline. By “substantially noncrystalline” is meant less than about 10% of the elastomeric compound is crystalline. It is essential that the elastomeric compounds of the invention are polysiloxane-free.

Preferred elastomeric compounds have a molecular weight less than about 10,000 and more preferably less than about 5,000.

Preferable elastomeric compounds include liquid poly(butadiene-co-acrylonitrile), liquid polybutadiene, liquid hydrogenated polybutadiene diol, ethylene-(meth)acrylic ester copolymers, poly(meth)acrylate ester elastomers, polychloroprene copolymers, hydrogenated poly(butadiene-co-acrylonitrile), polyepichlorohydrin, polysulfides, chlorinated polyethylene, chlorosulfonated polyethylene, fluoroelastomers, polyethylene plastomers, ethylene/propylene copolymers, and polystyrene-co-butadiene.

It is preferable that elastomeric compounds of the invention are functionally terminated.

Preferred functional terminations include amines, alcohols, carboxylic acids, thiols, and epoxies. More preferred functional terminations are vinyls. Even more preferred functional terminations are (meth)acrylates.

Hydrogenated polybutadiene diols are optionally converted to (meth)acrylate ends.

Ethylene-(meth)acrylic ester copolymers optionally include acid comonomers such as (meth)acrylic acid, itaconic acid, monomethyl maleate, and monoethyl maleate. Preferably, lower MW (higher melt index) forms of ethylene-(meth)acrylic ester copolymers are used to maintain better fluidity of the organic phase.

Preferred polychloroprenes are functionally terminated with vinyl monomers such as (meth)acrylic acid, alkyl (meth)acrylates, and 2,3-dichlorobutadiene.

Chlorinated or chlorosulfonated polyethylene are optionally copolymers with propylene or small amounts of alpha-olefin.

Fluoroelastomers are preferably based on vinylidene fluoride or hexafluoropropylene.

Polyethylene plastomers are preferably made from single-site catalysts.

Ethylene/propylene copolymers optionally contain diene monomer.

The elastomeric compound can be used in the range of about 2 weight percent to about 30 weight percent, preferably in the range of about 5 weight percent to about 25 weight percent, and more preferably in the range of about 10 to about 20 weight percent, the percentages being based on the total weight exclusive of filler.

Elastomeric compounds of the invention optionally can contain plasticizers. Suitable plasticizers can include, for example, phthalate esters such as di-2-ethylhexyl phthalate, di-isononyl phthalate, di-isodecyl phthalate, di-isoheptyl phthalate, di-isotridecyl phthalate, dibutyl phthalate, di-isobutyl phthalate, benzylbutyl phthalate, di-isoheptyl phthalate, and di-isoundecyl phthalate; adipate esters such as di-2-ethylhexyl adipate; citrate esters such as triethyl citrate, acetyl triethyl citrate, tributyl citrate, acetyl tributyl citrate, and tri-(2-ethylhexyl)-citrate; phosphate esters such as tris(2-ethylhexyl) phosphate and 2-ethylhexyl diphenyl phosphate; sebacate esters such as di-2-ethylhexyl sebacate and di-isodecyl sebacate; azelate esters such as di-2-ethylhexyl azelate; trimellitate esters such as tris-2-ethylhexyl trimellitate; and mixtures thereof.

The production of the crosslinked polymers useful in the practice of this invention from monomers and crosslinking agents may be performed by any of the many processes known to those skilled in the art. Thus, the polymers may be formed by heating a mixture of the components to a temperature sufficient to cause polymerization. For this purpose, peroxy-type initiators such as benzoyl peroxide, dicumyl peroxide, lauryl peroxide, tributyl hydroperoxide, and other materials familiar to those skilled in the art may be employed, and the use of activators may be advantageous in some formulations. Suitable activators include, for example, N,N-bis-(hydroxyalkyl)-3,5-xylidines, N,N-bis-(hydroxyalkyl)-3,5-di-t-butylanilines, barbituric acids and their derivatives, and malonyl sulfamides, including specific examples of these activators found in published U.S. patent application Ser. No. 2003/0008967. Azo-type initiators such as 2,2′-azobis(isobutyronitrile), 2,2′-azobis(2,4-dimethyl valeronitrile), 2,2′-azobis(2-methyl butane nitrile), and 4,4′-azobis(4-cyanovaleric acid) may also be used. Alternatively, the crosslinked polymers of the invention may be formed from the constituents by photochemical or radiant initiation utilizing light or high-energy radiation. For photochemical initiation, photochemical sensitizers, or energy transfer compounds may be employed to enhance the overall polymerization efficiency in manners well known to those skilled in the art.

Suitable photoinitiators include, for example, camphor quinone, benzoin ethers, a-hydroxyalkylphenones, acylphosphine oxides, α,α-dialoxyacetophenones, α-aminoalkylphenones, acyl phosphine sulfides, bis acyl phosphine oxides, phenylglyoxylates, benzophenones, thioxanthones, metallocenes, bisimidazoles, and α-diketones.

Photoinitiating accelerators may also be present. Such photoinitiating accelerators include, for example, ethyl dimethylaminobenzoate, dimethylaminoethyl methacrylate, dimethyl-p-toluidine, and dihydroxyethyl-p-toluidine.

According to another aspect, an inorganic filler is included in the composite. Included in the inorganic fillers are the preferred silicious fillers. More preferred are the inorganic glasses. Among these preferred inorganic fillers are barium aluminum silicate, lithium aluminum silicate, strontium fluoride, lanthanum oxide, zirconium oxide, bismuth phosphate, calcium tungstate, barium tungstate, bismuth oxide, tantalum aluminosilicate glasses, and related materials. Glass beads, silica, especially in submicron sizes, quartz, borosilicates, alumina, alumina silicates, and other fillers may also be employed. For example, Aerosil® OX-50 fumed silica from Degussa can be used. Mixtures of fillers may also be employed. The average diameter of the inorganic fillers is preferably less than 15 μm, even more preferably less than 10 μm.

Such fillers may be silanated prior to use in this invention. Silanation is well known to those skilled in the art and any silanating compound known to them may be used for this purpose. By “silanation” is meant that some of the silanol groups have been substituted or reacted with, for example, dimethyldichlorosilane to form a hydrophobic filler. The particles are typically from about 50 to about 95 percent silanated. Silanating agents for inorganic fillers include, for example, γ-mercaptoproyltrimethoxysilane, γ-mercaptopropyltriethoxysilane, γ-aminopropyltriethoxysilane, γ-methacryloyloxypropyltrimethoxysilane, and γ-methacryloyloxypropyltriethoxysilane.

The (meth)acrylic ester compounds can be used in the range of about 70 weight percent to about 98 weight percent, preferably in the range of about 75 weight percent to about 95 weight percent, and more preferably in the range of about 80 weight percent to about 90 weight percent, the percentages being based on the total weight exclusive of filler.

The polymerization initiator with, optionally, a photoinitiating accelerator can be used in the range of about 0.1 weight percent to about 5 weight percent, preferably in the range of about 0.2 weight percent to about 3 weight percent, and more preferably in the range of about 0.2 weight percent to about 2 weight percent, the percentages being based on the total weight exclusive of filler.

The inorganic filler can be used in the range of about 20 weight percent to about 90 weight percent, preferably in the range of about 40 weight percent to about 90 weight percent, and more preferably in the range of about 50 weight percent to about 85 weight percent, the percentages being based on the total weight of the (meth)acrylic ester compound, the polymerization initiator, the inorganic filler, and the elastomeric compound.

In addition to the components described above, the blend may contain additional, optional ingredients. These may comprise activators, pigments, radiopaquing agents, stabilizers, antioxidants, and other materials as will occur to those skilled in the art.

Suitable pigments include, for example, inorganic oxides such as titanium dioxide, micronized titanium dioxide, and iron oxides; carbon black; azo pigments; phthalocyanine pigments; quinacridone pigments; and pyrrolopyrrol pigments.

Preferred radiopaquing agents include, for example, ytterbium trifluoride, yttrium trifluoride, barium sulfate, bismuth subcarbonate, bismuth trioxide, bismuth oxichloride, and tungsten.

Preferred stabilizers include, for example, hydroquinone, hydroquinone monomethyl ether, 4-tert-butylcatechol, and 2,6-di-tert-butyl- 4-methylphenol.

Primary antioxidants, secondary antioxidants, and thioester-type antioxidants are all suitable for use in the dental compositions of the invention. Preferred primary antioxidants comprise hindered phenol and amine derivatives such as butylated hydroxytoluene, butylated hydroxyanisole, t-butyl hydroquinone, and α-tocopherol. Preferred secondary antioxidants include phosphites and phosphonites such as tris(nonylphenol) phosphite, tris(2,4-di-t-butylphenyl) phosphite, distearyl pentaerythritol diphosphite, bis(2,4-dicumylphenyl) pentaerythritol diphosphite, and Irgafos® P-EPQ (Ciba Specialty Chemicals, Tarrytown, N.Y.). Preferred thioester-type antioxidants, used synergistically or additively with primary antioxidants, include dilauryl 3,3′-thiodipropionate, dimyristyl 3,3′-thiodipropionate, distearyl 3,3′-thiodipropionate, and ditridecyl 3,3′-thiodipropionate.

Organic fillers, comprising prepolymerized material, optionally comprising at least one of the (meth)acrylic ester compounds and elastomeric compounds, and optionally comprising inorganic filler, may also be included in the composite material. Prepolymerization filler can be produced by any method known in the art, for example, by the method described in published U.S. patent application Ser. No. 2003/0032693. Optionally, uniformly-sized bead methacrylate polymers, such as Plexidon® or Plex® available from Röhm America LLC (Piscataway, N.J.), may be utilized as organic fillers.

The elastomeric compounds can be added directly to the monomers of the invention, followed by the addition of the fillers, or they can be added together with or after the fillers. For those elastomeric compounds that are soluble in the monomers of the invention, it is preferred that they be added to, and dissolved in, the monomers prior to the addition of fillers.

The dental composite materials of the present invention can be used in any treatment method known to one of ordinary skill in the art. Treatment in this context includes preventative, restorative, or cosmetic procedures using the dental composites of the present invention. Typically, without limiting the method to a specific order of steps, the dental composite materials are placed on a dental tissue, either natural or synthetic, the dental composite materials are cured by any method known to one of ordinary skill in the art, and the dental composite materials are shaped as necessary to conform with the target dental tissue. Dental tissue includes, but is not limited to, enamel, dentin, cementum, pulp, bone, and gingiva.

The dental composite materials of the present invention are suitable for a very wide range of dental uses, including fillings, teeth, bridges, crowns, inlays, onlays, laminate veneers, facings, pit and fissure sealants, cements, denture base and denture reline materials, orthodontic splint materials, and adhesives for orthodontic appliances. The materials of the invention may also be utilized for prosthetic replacement or repair of various hard body structures such as bone and may be utilized for reconstructive purposes during surgery, especially oral surgery. They are also useful for various non-dental uses as, for example, in plastic construction materials.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows: “hr.” means hour(s), “min.” means minute(s), “sec.” means second(s), “ml” means milliliter(s), “cm” means centimeter(s), “mm” means millimeter(s), “μm” means micron or micrometer, “g” means gram(s), “mmol” means millimole(s), “in.” means inch(es), “wt %” means weight percent(age), “mW” means milliwatt(s), “atm.” means atmosphere(s), “Mₙ” means number average molecular weight, “T_{g}” means glass transition temperature, “d50” means 50% of particles have a diameter below a given size, “d” means density, “AN” means acrylonitrile, “AA” means acrylic acid, “BD” means butadiene, “MW” means weight average molecular weight, “cps” means centipoise, “mp” means melting point, “HQ” means hydroquinone, “MPa” means megapascal(s), “CQ” means camphor quinone, “EDB” means ethyl 4-dimethylaminobenzoate, “THF” means tetrahydrofuran, “PTFE” means polytetrafluoroethylene.

### Materials and Supplies

Bis-GMA adduct was obtained from EssTech (Essington, Pa.)—product code X 950-0000. TEGDMA was obtained from EssTech—product code X 943-7424, inhibited with HQ (50-70 ppm). Photosensitizers were obtained from Sigma-Aldrich (St. Louis, Mo.): CQ (97%, catalog #12,489-3) and EDB (99+%, catalog #E2,490-5). Aerosil® OX-50 fumed silica was obtained from Degussa (Parsippany, N.J.). Schott 8235 UF1.5 glass powder was obtained from the Schott Corp. (Yonkers, N.Y.); it had a mean diameter, d50, of 1.5 μm and was treated with C₁₀H₂₀O₅Si to a level of 2.3 wt % silane. Liquid rubbers were obtained from Sigma-Aldrich: catalog #41,886-2 [18 wt % AN, dicarboxy terminated, Mₙ˜3,500, 1.8 COOH/molecule, 1,350 poise (27° C.), T_{g}=−52° C.]; catalog #41,890-0 [18 wt % AN, amine terminated, amine equivalent weight=900, 2,000 poise (27° C.), T_{g}=−51° C.]; catalog #41,892-7 [18 wt % AN, dicarboxy terminated, glycidyl methacrylate diester, d=1.000, CAS #1 18578-08-3, <0.64% AA, 2,500 poise (27° C.), T_{g}=−49° C.]; catalog #41,887-0 [10 wt % AN, dicarboxy terminated, Mₙ˜3,800, 1.9 COOH/molecule, 600 poise (27° C.), T_{g}=−66° C.], catalog #41,891-9 (polybutadiene, carboxy terminated, d=0.907, Mₙ˜4,200, 1.9 carboxyls/molecule, 600 poise, solubility parameter 8.14, 13-30% vinyl); and catalog #20,043-3 (polybutadiene, phenyl terminated, Mₙ˜1,800, d=0.930, 60% unsaturation). Other liquid rubbers were obtained from Scientific Polymer Products (Ontario, N.Y.): catalog #519 [poly(butadiene-co-acrylonitrile), dicarboxy terminated, 26% AN, 2.4% carboxyl, functionality 1.85, MW˜17,000, 570,000 cps, d=0.960, soluble in THF] and catalog #516 [poly(butadiene-co-acrylonitrile), vinyl terminated, 16% AN, acrylic vinyl 3.8%, vinyl equivalent weight 1,100, 250,000 cps, d=0.985, partly soluble in THF].

### Examples 1-4

A monomer-photosensitizer masterbatch was prepared under yellow light to avoid premature polymerization, with the ingredients indicated in Table 1.

TABLE 1

| | |
|---|---|
| Bis-GMA (EssTech), g | 15.0 |
| product code X 950 0000 | |
| TEGDMA (EssTech), g | 15.0 |
| inhibited with HQ (50-70 ppm), product | |
| code X 943 7424 | |
| Photosensitizers: | |
| CQ (97%, Aldrich), g* | 0.40 |
| EDB (99+%, Aldrich), g* | 0.40 |

*Sigma-Aldrich
Photo(co)sensitizers from Sigma-Aldrich:
1. Ethyl 4-dimethylaminobenzoate, 99+%, mp = 64-6° C., catalog #E2,490-5, MW = 193.2
2. CQ, 97%, mp = 198-200° C., catalog #12,489-3, MW = 166.2

Using the first recipe shown in Table 2, liquid rubber was mixed with a portion of the masterbatch in a small beaker covered with foil, under yellow light, with magnetic stirring for sufficient time to achieve maximum possible transparency. The remainder of the ingredients was added in the amounts shown in Table 2. After removing the stirring bar, the fumed silica was added to the contents of the beaker, mixed briefly in the beaker with a spatula, then turned out onto a 7 in.×12 in. glass plate. The mixture of masterbatch, liquid rubber, and fumed silica was mixed on the plate with a larger spatula until uniform and clear. The glass powder was then added in several portions to the beaker and stirred to combine it with the remainder of the previous mixture, then added to the mixture on the plate. Mixing was continued for a total of 10 min. The mixture was kneaded between PTFE sheets (flattened, folded over, and flattened again) for 65 cycles. The procedure was repeated for each recipe shown in Table 2.

TABLE 2

| | Example: | | | |
|---|---|---|---|---|
| | 1 | 2 | 3 | 4 |
| Monomer/photosensitizer | 4.0 | 4.0 | 4.0 | 4.0 |
| masterbatch, g | | | | |
| Poly(acrylonitrile-co-butadiene) | | | | |
| liquid rubber, mixed into | | | | |
| masterbatch until maximum | | | | |
| possible transparency achieved:* | | | | |
| 18 wt % AN, dicarboxy terminated, | 1.0 | — | — | — |
| #41,886-2, g* | | | | |
| 18 wt % AN, amine terminated, | — | 1.0 | — | |
| #41,890-0, g* | | | | |
| 18 wt % AN, dicarboxy terminated, | — | — | 1.0 | — |
| glycidyl methacrylate diester, | | | | |
| #41,892-7, g* | | | | |
| 10 wt % AN, dicarboxy terminated, | — | — | — | 1.0 |
| 41,887-0, g* | | | | |
| Added to pre-mixed | | | | |
| monomers/photosensitizer/ | | | | |
| rubber: | | | | |
| 1^{st}: Degussa OX-50 fumed silica | 1.0 | 1.0 | 1.0 | 1.0 |
| (0.04 μm), g** | | | | |
| 2^{nd}: Schott 8235 (Ba silicate) UF1.5 | 14.0 | 14.0 | 14.0 | 14.0 |
| glass powder (d50 = 1.5 μm, 2.3 wt % | | | | |
| silane), g** | | | | |
| Hand-mix time, min. | 10 | 10 | 10 | 10 |
| Kneading, fold cycles [˜10 min.] | 65 | 65 | 65 | 65 |

*#'s cited are Sigma-Aldrich catalog #'s:
#41,886-2: 18 wt % AN, dicarboxy terminated, Mₙ˜3,500, 1.8 COOH/molecule, 1,350 poise (27° C.), T_{g} = −52° C.
#41,890-0: 18 wt % AN, amine terminated, amine equivalent weight = 900, 2,000 poise (27° C.), T_{g} = −51° C.
#41,892-7: 18 wt % AN, dicarboxy terminated, glycidyl methacrylate diester, d = 1.000, CAS#118578-08-3, <0.64% AA, 2,500 poise (27° C.), Tg = −49° C.
#41,887-0: 10 wt % AN, dicarboxy terminated, Mₙ˜3,800, 1.9 COOH/molecule, 600 poise (27° C.), T_{g} = −66° C.
**Degussa OX-50 fumed silica: 5 wt % of total composition-added to masterbatch first. Schott 8235 UF1.5* (d50 = 1.5 μm, d99 < 5 μm) 2.3 wt % silane [*B₂O₃ (10%), Al₂O₃ (10%), SiO₂ (50%), BaO (30%), plus silane, C₁₀H₂₀O₅Si (˜2%)].

The mixtures were degassed in a desiccator with vacuum pump, cycling between atmospheric pressure and full vacuum every 10 min. for 1 hr, then holding at 50 mm Hg overnight (-16 hr). The mixtures were further degassed overnight at 45° C. in a vacuum oven with just enough vacuum to keep the oven door closed, then isolating the oven by closing off all gas inlet/outlet valves. The mixtures were wrapped in foil to exclude light and stored in a refrigerator until used. For measurements or curing under a Dentsply Specturm 800 dental light, they were removed from the refrigerator, and the mixtures were allowed to warm to room temperature prior to use.

Shrinkage was determined by measuring the densities (with a Micromeritics Corp. AccuPyc 1330 Helium Pycnometer) of uncured mixtures and of the bars cured under the dental lights under the following conditions. In a mold cut from PTFE were cured three bars of dimension ˜2(depth)×4×25 mm. The uncured mixture was packed into the mold and sandwiched between two polyester plastic sheets and two glass plates. Three dental curing lamps (model Spectrum 800 from Dentsply, set at a visible light intensity of 550 mW/cm²), each bearing an 8-mm light tip, were lined up and tied together to cure one side of one bar all at once. The light tips were brought up to the glass plate that covered the polyester sheet, which covered the dental composite and mold. Each bar was cured for 2 min. on the top and then 2 min. on the bottom. The volumetric shrinkage was calculated from the formula: Shrinkage=(cured density−uncured density)/(cured density).

The degree of monomer polymerization (“conversion”) was measured by Fourier Transform Infrared spectroscopy, using the total attenuated reflectance (ATR) method. A new, small metal file was cleaned with soap/water (scrubbing), then deionized water, then acetone, gently dabbed with a towel to absorb moisture, and air-dried. A bar of each composition was cured for the times specified in Table 3, at 550 mW/cm² under the following conditions. The uncured composition was packed into a stainless steel mold with a 2×2×25 mm cavity and sandwiched with two polyester sheets and two glass plates. Cured bars were obtained in the same manner as described for the bars used for shrinkage determination, except that the cure times (top and bottom of the bar) were varied as shown in Table 3.

Each bar was broken near center, just before filing it down to obtain powder for analysis. The powders were stored in vials wrapped in aluminum foil. The degree of conversion was obtained by comparing the relative peak heights ratios before and after cure. The peak ratio was calculated by dividing the height of the methacrylate C═C peak at 1,640 cm⁻¹ by the height of the aromatic peak at 1,610 cm⁻¹.

TABLE 3

Example:

| | 1 | 2 | 3 | 4 |
|---|---|---|---|---|
| No cure | 1A | 2A | 3A | 4A |
| Light cure time (top and | | | | |
| bottom of bar) | | | | |
| 60 sec. | 1B | 2B | 3B | 4B |
| 120 sec. | 1C | — | 3C | — |

Fracture toughness (K_{IC}) and flexural strength (ISO 4049) were obtained by standard methods on bars cured under the following conditions. Each uncured composition was packed into a stainless steel mold with a 2×2×25 mm cavity and sandwiched with two polyester sheets and two glass plates. Cured bars were obtained in the same manner as described for the bars used for shrinkage determination, except that the cure time was limited to 60 sec. on the top and bottom of each bar. Five bars were used for each of the two mechanical tests. The bars were stored in glass vials until use and conditioned in water for 24 hr at 37° C., just prior to the tests.

The fracture toughness test was based on both the ASTM polymers standard (ASTM D5045) and the ASTM ceramics standard (ASTM C1421, precracked beam method). Testing was conducted at a test speed of 0.5 mm/min. at room temperature and ambient humidity using a three-point bend fixture (span to depth ratio of 10). The specimens were molded using the flex bar mold specified in ISO 4049. The specimens were precracked halfway through the depth. Two modifications to the test procedures were made. The first was the use of smaller test specimens than those recommended in the ASTM C1421 standard (2 mm×2 mm×25 mm instead of the recommended minimum dimensions of 3 mm×4 mm×20 mm). The second was the use of a slitting circular knife to machine the precracks. The knife was 0.31 mm in thickness with a 9 degree single bevel. Tests have shown that this technique produced precracks that were equivalent to precracks produced using techniques recommended in ASTM D5045.

The properties of the compositions are summarized in Table 4.

TABLE 4

| | | | K_{IC} | Flexural | |
|---|---|---|---|---|---|
| | Cure | Conversion | (MPa- | Strength | Shrinkage |
| Sample # | time | (FTIR) | m^{1/2}) | (MPa) | (Hepycnometry) |
| Example 1 | | | | | |
| 1B | 60-sec. | 82.3% | 1.18 | 68 | |
| 1C | 120-sec. | 81.1% | | | 3.76% |
| Example 2 | | | | | |
| 2B | 60-sec. | 86.0% | 1.2 | 60 | |
| 2C | 120-sec. | | | | 2.59% |
| Example 3 | | | | | |
| 3B | 60-sec. | 87.9% | 1.89 | 122 | |
| 3C | 120-sec. | 88.4% | | | 3.85% |
| Example 4 | | | | | |
| 4B | 60-sec. | 81.8% | 1.18 | 120 | |
| 4C | 120-sec. | | | | 3.83% |

### Comparative Examples A and B

A monomer-photosensitizer masterbatch with the same ingredients shown in Table 1 was prepared under yellow light. The ingredients shown in Table 5 were mixed according to the procedure shown in Examples 1-4 and the composition tested as described in Examples 1-4, except that flexural strength and conversion were not determined.

TABLE 5

| | Example: |
|---|---|
| | A |
| Monomer/photosensitizer masterbatch, g | 5.0 |
| Added to pre-mixed | |
| monomers/photosensitizer: | |
| 1^{st}: Degussa OX-50 fumed silica (0.04 μm), g | 1.0 |
| 2^{nd}: Schott 8235 (Ba silicate) UF1.5 glass powder | 14.0 |
| (d50 = 1.5 μm, 2.3 wt % silane), g | |
| Hand-mix time, min. | 10 |
| Kneading, fold cycles [˜10 min.] | 65 |

Duplicate sets of properties were determined and are summarized in Table 6 as Examples A and B. The shrinkage value is greater than for the compositions of Examples 1-4.

TABLE 6

| | | Con- | | Flexural | |
|---|---|---|---|---|---|
| | Cure | version | K_{IC} | Strength | Shrinkage |
| Sample # | time | (FTIR) | (MPa-m^{1/2}) | (MPa) | (Hepycnometry) |
| Example | 60-sec. | | 1.85 | | |
| A | 120-sec. | | | | 4.50% |
| Example | 60-sec. | | 1.84 | | |
| B | 120-sec. | | | | 4.51% |
| Example | 60-sec. | 85.2% | 1.74 | 120 | |
| C | 120-sec. | | | | 4.30% |
| Example | 60-sec. | 87.5% | 1.77 | 119 | |
| D | 120-sec. | | | | 4.73% |

### Comparative Examples C and D

The ingredients in Table 7 were mixed according to the procedure described for Examples 1-4, except that no monomer masterbatch/photosensitizer was prepared, and tested in the same manner. The properties are summarized in Table 6. The shrinkage values are greater than for the compositions of Examples 1-4.

TABLE 7

| | Example: | |
|---|---|---|
| | C | D |
| Bis-GMA (EssTech), g | 3.0 | 2.0 |
| product code X 950 0000 | | |
| TEGDMA (EssTech), g | 2.0 | 3.0 |
| inhibited with HQ (50-70 ppm), product code X 943 7424 | | |
| Photosensitizers: | | |
| CQ (97%, Sigma-Aldrich), g | 0.05 | 0.05 |
| EDB (99+%, Sigma-Aldrich), g | 0.05 | 0.05 |
| Added to pre-mixed monomers/photosensitizer: | | |
| 1^{st}: Degussa OX-50 fumed silica (0.04 μm), g | 1.0 | 1.0 |
| 2^{nd}: Schott 8235 (Ba silicate) UF1.5 glass powder | 14.0 | 14.0 |
| (d50 = 1.5 μm, 2.3 wt % silane), g | | |
| Hand-mix time, min. | 10 | 10 |
| Knead time, min. [10 min. = 65 fold cycles] | 10 | 10 |

### Examples 5-8

A monomer-photosensitizer masterbatch with the same ingredients shown in Table 1 was prepared under yellow light. The ingredients shown in Table 8 were mixed according to the procedure shown in Examples 1-4 10 and the compositions tested as described in Examples 1-4. The results are summarized in Table 9.

TABLE 8

| | Example: | | | |
|---|---|---|---|---|
| | 5 | 6 | 7 | 8 |
| Monomer/photosensitizer masterbatch, g | 4.0 | 4.0 | 4.0 | 4.0 |
| Liquid rubber, mixed into | | | | |
| masterbatch until maximum | | | | |
| possible transparency achieved:* | | | | |
| Poly(butadiene-co-acrylonitrile), | 1.0 | — | — | — |
| dicarboxy terminated; 26% AN, SP² | | | | |
| #519, g | | | | |
| Poly(butadiene-co-acrylonitrile), vinyl | — | 1.0 | — | — |
| terminated; 16% AN, acrylic vinyl | | | | |
| 3.8%, SP² #516, g | | | | |
| Polybutadiene, carboxy terminated; 1.9 | — | — | 1.0 | — |
| carboxyls/molecule, Sigma-Aldrich | | | | |
| #41,891-9, g | | | | |
| Polybutadiene, phenyl terminated; | — | — | — | 1.0 |
| Mₙ˜1800, Sigma-Aldrich #20,043-3, g | | | | |
| Added to pre-mixed | | | | |
| monomers/photosensitizer/ | | | | |
| rubber: | | | | |
| 1^{st}: Degussa OX-50 fumed | 1.0 | 1.0 | 1.0 | 1.0 |
| silica (0.04 μm), g | | | | |
| 2^{nd}: Schott 8235 (Ba silicate) UF1.5 | 14.0 | 14.0 | 14.0 | 14.0 |
| glass powder (d50 = 1.5 μm, 2.3 wt % | | | | |
| silane), g | | | | |
| Hand-mix time, min. | 10 | 10 | 10 | 10 |
| Kneading, fold cycles [˜10 min.] | 65 | 65 | 65 | 65 |

*#519: Poly(butadiene-co-acrylonitrile), dicarboxy terminated; 26% AN, 2.4% carboxyl, Functionality 1.85, MW˜17,000, 570,000 cps, d = 0.960, soluble in THF
#516: Poly(butadiene-co-acrylonitrile), vinyl terminated; 16% AN, acrylic vinyl 3.8%, vinyl equivalent weight = 1,100, 250,000 cps, d = 0.985, partly soluble in THF
#41,891-9: Polybutadiene, carboxy terminated; d = 0.907, Mₙ˜4,200, 1.9 carboxy/molecule, 600 poise, solubility parameter 8.14, 13-30% vinyl
#20,043-3: Polybutadiene, phenyl terminated; Mₙ˜1,800, d = 0.930, 60% unsaturation

TABLE 9

| | | Con- | | Flexural | |
|---|---|---|---|---|---|
| | Cure | version | K_{IC} | Strength | Shrinkage |
| Sample # | time | (FTIR) | (MPa-m^{1/2}) | (MPa) | (Hepycnometry) |
| Example 5 | | | | | |
| 5B | 60-sec. | 82.1% | 1.45 | 103 | |
| 5C | 120-sec. | 81.4% | | | 3.69% |
| Example 6 | | | | | |
| 6B | 60-sec. | 84.5% | 1.69 | 115 | |
| 6C | 120-sec. | | | | 3.72, 3.81% |
| Example 7 | | | | | |
| 7B | 60-sec. | 73.6% | 1.16 | 72 | |
| 7C | 120-sec. | 73.6% | | | 3.49% |
| Example 8 | | | | | |
| 8B | 60-sec. | 57.8% | 1.55 | 91 | |
| 8C | 120-sec. | 56.5% | | | 3.45% |

### Examples 9-12

A monomer masterbatch was prepared with the ingredients indicated in Table 10.

TABLE 10

| | |
|---|---|
| Bis-GMA (EssTech), g | 15.0 |
| product code X 950 0000 | |
| TEGDMA (EssTech), g | 15.0 |
| inhibited with HQ (50-70 ppm), product code | |
| X 943 7424 | |

In 5.0 g acetone was dissolved 0.5 g or 1.0 g of the ethylene copolymer specified in Table 11. The acetone solution was combined with the amount of masterbatch specified in Table 11 and mixed with a magnetic stirrer until one-phase. Under yellow light, the photosensitizers were added to the mixtures, followed by the other ingredients specified in Table 11. The ingredients were mixed according to the procedure shown in Examples 1-4 and the compositions tested as described in Examples 1-4, except that conversion was not determined. The results are summarized in Table 12.

The copolymers shown in Table 11 are composed of monomers selected from the following: ethylene (“E”), methyl acrylate (“MA”), methyl methacrylate (“MMA”), lauryl methacrylate (“LMA”), 2-ethylhexyl acrylate (“EHA”), and a monomer of formula weight approximately 150 bearing a carboxylic acid group (“Mon”). Where numbers precede the monomer designation, they represent the approximate wt % of the corresponding monomer. The copolymers are fluid at 190° C., yielding melt flow rate (“MI”) values corresponding to the number of g/10 min. shown in the Table, under a 2,160-g weight.

TABLE 11

| | Example: | | | |
|---|---|---|---|---|
| | 9 | 10 | 11 | 12 |
| Acetone, g | 5.0 | 5.0 | 5.0 | 5.0 |
| Ethylene copolymer | | | | |
| E/26MMA/37LMA/1.7Mon (1630 MI), g | 0.5 | — | — | — |
| E/MA/2-EHA/3.9Mon (37 MI), g | — | 0.5 | — | — |
| E/MA/2-EHA/4.4Mon (116 MI), g | — | | 0.5 | 1.0 |
| After dissolved: | | | | |
| Masterbatch, 50:50 Bis-GMA/TEGDMA, g | 4.5 | 4.5 | 4.5 | 4.0 |
| Photosensitizers: | | | | |
| CQ (97%, Sigma-Aldrich), g* | 0.05 | 0.05 | 0.05 | 0.05 |
| EDB (99+%, Sigma-Aldrich), g* | 0.05 | 0.05 | 0.05 | 0.05 |
| Added to pre-mixed | | | | |
| monomers/polymer/photosensitizer: | | | | |
| 1^{st}: Degussa OX-50 fumed silica (0.04 μm), | 1.0 | 1.0 | 1.0 | 1.0 |
| g** | | | | |
| 2^{nd}: Schott 8235 (Ba silicate) UF1.5 glass | 14.0 | 14.0 | 14.0 | 14.0 |
| powder (d50 = 1.5 μm, 2.3 wt % silane), | | | | |
| g** | | | | |
| Hand-mix time, min. | 10 | 10 | 10 | 10 |
| Kneading, fold cycles [˜10 min.] | 65 | 65 | 65 | 65 |

TABLE 12

| | | Con- | K_{IC} | Flexural | |
|---|---|---|---|---|---|
| | Cure | version | (MPa- | Strength | Shrinkage |
| Sample # | time | (FTIR) | m^{1/2}) | (MPa) | (Hepycnometry) |
| Example 9 | | | | | |
| 9B | 60-sec. | | 1.66 | 111 | |
| 9C | 120-sec. | | | | 3.83% |
| Example 10 | | | | | |
| 10B | 60-sec. | | 1.65 | 108 | |
| 10C | 120-sec. | | | | 3.66% |
| Example 11 | | | | | |
| 11B | 60-sec. | | 1.82 | 116 | |
| 11C | 120-sec. | | | | 3.88% |
| Example 12 | | | | | |
| 12C | 120-sec. | | | | 3.412, 3.34% |

1. A composite material comprising:
(a) at least one polysiloxane-free, substantially noncrystalline elastomeric compound having a T_{g} of less than about 20° C. and a melt index of at least about 100 g/10 min. at 190° C.; and
(b) at least one (meth)acrylic ester compound; and
(c) at least one polymerization initiator.

2. The composite material of claim 1 further comprising at least one inorganic filler.

3. The composite material of claim 2, wherein the at least one polysiloxane-free, substantially noncrystalline elastomeric compound is present in an amount of from about 2 to about 30 weight percent, the at least one (meth)acrylic ester compound is present in an amount of from about 70 to about 98 weight percent, the at least one polymerization initiator is present in an amount of from about 0.1 to about 5 weight percent, and the at least one inorganic filler is present in an amount of from about 20 to about 90 weight percent.

4. The composite material of claim 1, wherein the at least one polysiloxane-free, substantially noncrystalline elastomeric compound comprises at least one of a liquid poly(butadiene-co-acrylonitrile), a liquid polybutadiene, a liquid hydrogenated polybutadiene diol, and an ethylene-(meth)acrylic ester copolymer, wherein the liquid poly(butadiene-co-acrylonitrile), the liquid polybutadiene, and the liquid hydrogenated polybutadiene diol optionally are functionally terminated with vinyl, acrylate, or methacrylate.

5. The composite material of claim 1 further comprising at least one of a photoinitiating accelerator, an activator, a pigment, a radiopaquing agent, a stabilizer, and an antioxidant.

6. A dental composite material comprising at least one polysiloxane-free, substantially noncrystalline elastomeric compound having a T_{g} of less than about 20° C. and a melt index of at least about 100 g/10 min. at 190° C.

7. The dental composite material of claim 6, wherein the at least one polysiloxane-free, substantially noncrystalline elastomeric compound is present in an amount of from about 2 to about 30 weight percent.

8. The dental composite material of claim 6, wherein the at least one polysiloxane-free, substantially noncrystalline elastomeric compound comprises at least one of a liquid poly(butadiene-co-acrylonitrile), a liquid polybutadiene, a liquid hydrogenated polybutadiene diol, and an ethylene-(meth)acrylic ester copolymer, wherein the liquid poly(butadiene-co-acrylonitrile), the liquid polybutadiene, and the liquid hydrogenated polybutadiene diol optionally are functionally terminated with vinyl, acrylate, or methacrylate.

9. The dental composite material of claim 6 further comprising about 70 to about 98 percent by weight at least one (meth)acrylic ester compound.

10. The dental composite material of claim 6 further comprising about 0.1 to about 5 percent by weight at least one polymerization initiator.

11. The dental composite material of claim 6 further comprising about 20 to about 90 percent by weight inorganic filler.

12. The dental composite material of claim 6 further comprising at least one of a photoinitiating accelerator, an activator, a pigment, a radiopaquing agent, a stabilizer, and an antioxidant.

13. A method for producing a dental restoration article with reduced shrinkage, comprising the steps of:
(a) mixing at least one polysiloxane-free, substantially noncrystalline elastomeric compound with a T_{g} of less than about 20° C. and a melt index of at least about 100 g/10 min. at 190° C. with at least one (meth)acrylic ester compound, at least one polymerization initiator, and, optionally, at least one inorganic filler; and
(b) forming and curing the dental restoration article.

14. The method of claim 13, wherein the at least one polysiloxane-free, substantially noncrystalline elastomeric compound is present in an amount of from about 2 to about 30 weight percent, the at least one (meth)acrylic ester compound is present in an amount of from about 70 to about 98 weight percent, the at least one polymerization initiator is present in an amount of from about 0.1 to about 5 weight percent, and the at least one inorganic filler is present in an amount of from about 20 to about 90 weight percent

15. The method of claim 13, wherein the at least one polysiloxane-free, substantially noncrystalline elastomeric compound comprises at least one of a liquid poly(butadiene-co-acrylonitrile), a liquid polybutadiene, a liquid hydrogenated polybutadiene diol, and an ethylene-(meth)acrylic ester copolymer, wherein the liquid poly(butadiene-co-acrylonitrile), the liquid polybutadiene, and the liquid hydrogenated polybutadiene diol optionally are functionally terminated with vinyl, acrylate, or methacrylate.

16. The method of claim 13, wherein the dental restoration article further comprises at least one of a photoinitiating accelerator, an activator, a pigment, a radiopaquing agent, a stabilizer, and an antioxidant.

17. The method of claim 13, wherein the dental restoration article is selected from fillings, artificial teeth, bridges, crowns, inlays, onlays, laminate veneers, facings, pit sealants, fissure sealants, cements, denture base materials, denture reline materials, orthodontic splint materials, and adhesives for orthodontic appliances.

18. A dental filling comprising the composition of claim 1.

19. A dental inlay, onlay, facing, or laminate veneer comprising the composition of claim 1.

20. A dental crown, bridge, or orthodontic splint material comprising the composition of claim 1.

21. A dental adhesive, cement, sealant, or an adhesive for orthodontic appliances comprising the composition of claim 1.

22. An artificial tooth, denture base, or denture reline material comprising the composition of claim 1.

23. A method of treating dental tissue with a direct composite, comprising the steps of:
(a) placing the composite material of claim 1 on a dental tissue;
(b) curing the composite material; and
(c) shaping the composite material.
